(19) United States
(12) Patent Application Publication
(10) Pub. No.: US 2006/0133875 A1
(43) Pub. Date: Jun. 22, 2006

(54) Image forming apparatus, paper sheet transporting device, and paper sheet feeding device

(75) Inventors: Naofumi Okada, Tenri-shi (JP); Jinichi Nagata, Osaka (JP); Toshiki Ohgita, Shiki-gun (JP); Kouzou Yamaguchi, Kashihara-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/312,520

(22) Filed: Dec. 21, 2005

(30) Foreign Application Priority Data
Dec. 22, 2004 (JP) 2004-370308

(51) Int. Cl. G03G 15/00

(52) U.S. Cl. 399/392

(57) ABSTRACT

An image forming apparatus 1 is arranged such that a manual paper sheet feeding section 14 is detachably installed in a position corresponding to a manual transportation path 13. Further, the manual paper sheet feeding section 14 may be detached from the manual transportation path 13. With this, a paper sheet feeding device 30 can be installed in the position so that a paper sheet feeding vent 32 corresponds to the manual transportation path 13. Moreover, the manual paper sheet feeding section 14 thus detached can be installed so that a paper sheet feeding vent 149 corresponds to a paper sheet input vent 22 provided in a reverse transportation unit 15 connected to a reverse transportation path 21. This allows supply of paper sheets from both the paper sheet feeding device 30 and the manual paper sheet feeding section 14.

This Nonprovisional application claims priority under 35 U.S.C. § 119(a) on Patent Application No. 370308/2004 filed in Japan on Dec. 22, 2004, the entire contents of which are hereby incorporated by reference.

### FIELD OF THE INVENTION

The present invention relates to an image forming apparatus, a paper sheet transporting device to be installed in the image forming apparatus, and a paper sheet feeding device to be installed in the image forming apparatus.

### BACKGROUND OF THE INVENTION

In recent years, a processing speed of image formation carried out by an image forming apparatus has become increasingly high. In addition, there has been a demand for an image forming apparatus capable of carrying out the image formation with respect to a large number of recording paper sheets. (Such image formation is hereinafter referred to as “large-capacity image formation”.) In response to such a demand, there is being developed a large-capacity paper sheet feeding device. In addition to a standard paper sheet feeding cassette (normally capable of storing approximately 500 paper sheets), the large-capacity paper sheet feeding device can be added as an option to the image forming apparatus. Normally, the large-capacity paper sheet feeding device adopts such an arrangement that: the large-capacity paper sheet feeding device stores a large number of paper sheets of one type, and the paper sheets are supplied from the large-capacity paper sheet feeding device when the paper sheets contained in the paper sheet feeding cassette are in short. Further, proposed is such an arrangement that: a plurality of paper sheet feeding storage sections storing plural types of paper sheets are provided on top of one another (e.g., see Japanese Unexamined Patent Publication No. 193766/1993 (Tokukaihei 5-193766; published on Aug. 3, 1993) (Patent Document 1)).

FIG. 7 is a diagram schematically illustrating a paper sheet feeding device installed in a conventional image forming apparatus described in Patent Document 1. As illustrated in FIG. 7, the image forming apparatus 70 includes an image forming section 71, a paper sheet feeding section 72, and a fixing section 73. The image forming section 71 carries out the image formation in accordance with an electrophotographic process. The paper sheet feeding section 72 feeds paper sheets to the image forming section 71. The fixing section 73 is provided in midstream of a transportation path for use in ejecting, to outside of the image forming apparatus 1, the paper sheet subjected to the image formation carried out by the image forming section 71. The paper sheet feeding section 72 has paper sheet feeding cassettes 72a and 72b which are provided on top of each other. The paper sheet feeding cassettes 72a and 72b store the paper sheets of different sizes. The paper sheets are fed from selected one of the paper sheet feeding cassettes 72a and 72b to the image forming section 71. Each of the paper sheets thus fed is subjected to the image formation carried out by the image forming section 71. Then, the paper sheet passes through the fixing section 73. Thereafter, the paper sheet loops back such that the image formation is carried out with respect to both sides of the paper sheet. The paper sheet thus reversed is transported to the image forming section 71 again via a sub-transportation path 74.

Further, in addition to the paper sheet feeding section 72 built in the image forming apparatus 70, the image forming apparatus 70 is provided with a manual paper sheet feeding path 75 for feeding a paper sheet of a given size to the image forming section 71. The manual paper sheet feeding section 75 has a paper sheet input vent. Provided in the paper sheet input vent is a manual paper feeding section (not shown), so that the paper sheet manually fed is transported to the image forming section 71.

In addition to the paper sheet feeding section 72 built in the image forming apparatus 70 thus arranged, an external paper sheet feeding device 76 is provided in the image forming apparatus 70 such that the external paper sheet feeding device 76 can be installed as an option in the image forming apparatus 70. The external paper sheet feeding device 76 is installed in the image forming apparatus 70 so as to be connected to the manual paper sheet feeding path 75 of the manual paper sheet feeding section. The external paper sheet feeding device 76 has, e.g., three paper sheet feeding storage sections 76a, 76b, and 76c, each of which can store a larger number of paper sheets than does the paper sheet feeding section 72 in the image forming apparatus 70. The paper sheet feeding storage sections 76a, 76b, and 76c are provided on top of one another in a descending order from the paper sheet feeding storage section 76a to the paper sheet feeding storage section 76c. Paper sheet feeding is carried out from the uppermost paper sheet in each of the paper sheet feeding storage sections 76a, 76b, and 76c. The paper sheet thus fed is transported to the image forming section 71 via the manual paper sheet feeding path 75.

In the arrangement illustrated in FIG. 7, the large-capacity paper sheet feeding device 76 to be installed in the image forming apparatus 70 has the plural paper sheet feeding storage sections 76a, 76b, and 76c which store different types of paper sheets and which are provided on top of one another. This makes it impossible to use the manual paper feeding section normally provided as a standard component in the image forming apparatus 70. That is, although a large number of paper sheets of a predetermined size can be fed automatically, the image formation cannot be carried out with respect to one or more paper sheets which have given sizes and which are fed manually.

Since the manual paper sheet feeding section has an advantage of allowing a user to easily carry out the image formation with respect to one or a small number of paper sheets of a given size, the user finds the manual paper sheet feeding section to be useful. On the other hand, when the manual paper sheet feeding section cannot be used, the user is put to inconvenience in carrying out the image formation with respect to a small number (including one) of paper sheets of a given size.

Further, in the example of the large-capacity paper sheet feeding device illustrated in FIG. 7, transportation paths are so formed as to extend from the paper sheet feeding storage sections 76a, 76b, and 76c to the manual paper sheet feeding path 75. From the manual paper sheet feeding path 75 at which the transportation paths meet together, the paper sheet is fed to the image forming device 70. Each of the transportation paths thus formed in the paper sheet feeding device 76 has a plurality of bent portions. In other words, the bent portions are inevitably formed in such a limited space of the paper sheet feeding device 76. With this, during paper sheet transportation, a paper sheet jam, oblique paper sheet transportation, or the like is likely to occur in the bent portions or at the point at which the transportation paths meet.

### SUMMARY OF THE INVENTION

It is a first object of the present invention to provide (i) an image forming apparatus that allows manual paper sheet feeding even when a paper sheet feeding device is so installed as to be connected to a transportation path instead of a manual paper sheet feeding section, (ii) a paper sheet transporting device to be installed in the image forming apparatus, and (iii) a paper sheet feeding device to be installed in the image forming apparatus.

It is a second object of the present invention to prevent such a problem that, when paper sheet transportation paths respectively extending from the manual paper sheet feeding section and the paper sheet feeding device meet at one point, a jam or the like is likely to occur at the meeting point.

In order to solve the foregoing problems, an image forming apparatus of the present invention includes: an image forming section for carrying out image formation with respect to a paper sheet fed thereto: a manual paper sheet feeding section, which allows supply of an arbitrary paper sheet; and a plurality of transportation paths for receiving, from outside, the paper sheet to be transported to the image forming section, the manual paper sheet feeding section being detachably installed so as to be connected to an arbitrary transportation path selected from the transportation paths.

Thus, even when another paper sheet feeding device (e.g., large-capacity paper sheet feeding device) is so installed as to be connected to the transportation path instead of the manual paper sheet feeding section, the manual paper sheet feeding section can be connected to another transportation path. Therefore, even when the paper sheet feeding device is installed, the manual paper sheet feeding section can be used to feed the paper sheet. In this case, since the manual paper sheet feeding section and the paper sheet feeding device are connected to the different transportation paths, the paths do not meet at one point. This makes it possible to prevent a jam or the like, thereby allowing stable paper sheet feeding.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a cross-sectional view illustrating a paper sheet feeding device and a manual paper sheet feeding section installed in an image forming apparatus according to one embodiment of the present invention.

FIG. 2 is a cross-sectional view illustrating that the manual paper sheet feeding section is installed in the image forming apparatus according to the embodiment of the present invention.

FIG. 3 is a perspective view illustrating the manual paper sheet feeding section to be installed in the image forming apparatus according to the embodiment of the present invention.

FIG. 4 is a cross-sectional view illustrating the manual paper sheet feeding section to be installed in the image forming apparatus according to the embodiment of the present invention.

FIG. 5 is a block diagram illustrating an internal structure of another example of the forming apparatus according to the first embodiment of the present invention.

FIG. 6 is a cross-sectional view illustrating that a paper sheet feeding device capable of feeding a plurality of types of paper sheet, and a manual paper feeding section are installed in an image forming apparatus according to another embodiment of the present invention.

FIG. 7 is a schematic diagram illustrating a conventional image forming apparatus including an external paper sheet feeding device.

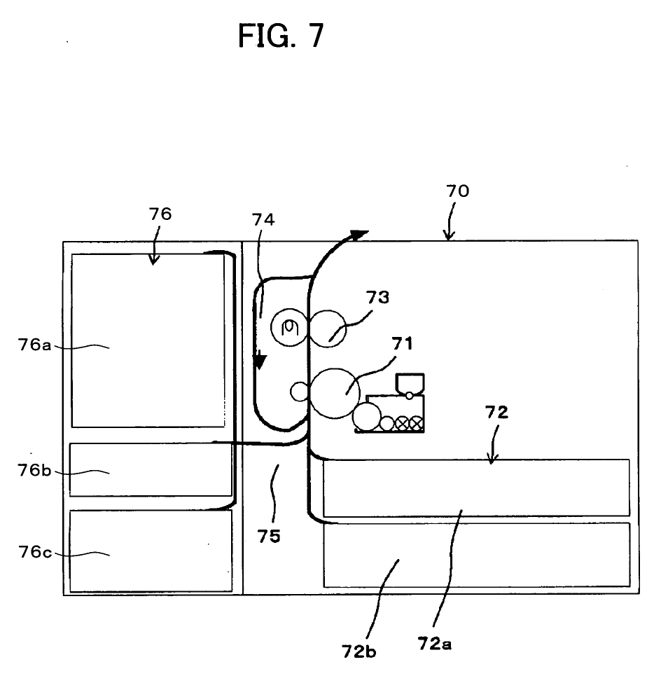

### DESCRIPTION OF THE EMBODIMENTS

### First Embodiment

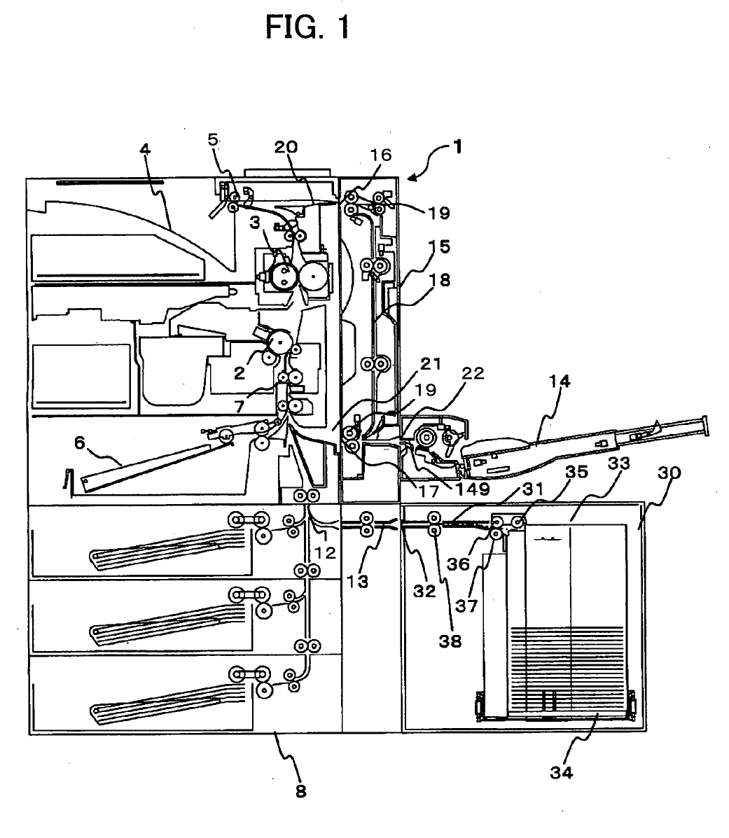

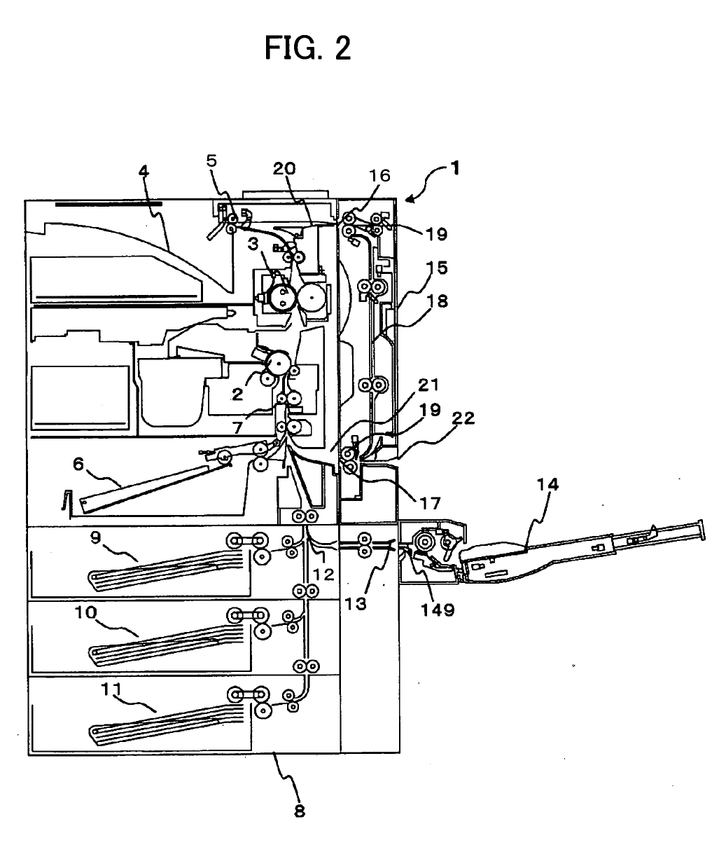

An embodiment of the present invention will be described below with reference to the drawings. FIGS. 1 and 2 are cross-sectional views illustrating arrangements of an image forming apparatus according to the present embodiment. FIG. 1 illustrates a case where a paper sheet feeding device 30 and a manual paper sheet feeding section 14 are installed in the image forming apparatus. FIG. 2 illustrates a case where the paper sheet feeding device 30 is not installed but the manual paper feeding section 14 is installed in the image forming apparatus.

First, the image forming apparatus 1 according to the present embodiment will be described with reference to FIG. 2. The image forming apparatus 1 uses an image forming process section serving as an image forming section, in order to carry out image formation with respect to each of paper sheets. The image forming process section serving as the image forming section adopts the electrophotographic method, and includes a charging section, an image exposing section, a developing section, a transfer section, a cleaning section, and an electricity removing section. The charging section, the image exposing section, the developing section, the transfer section, the cleaning section, and the electricity removing section are so provided around a drum-type photoreceptor 2 in this order as to be in a rotation direction of the photoreceptor 2. The photoreceptor 2 is an image forming carrier that rotates anticlockwise in FIG. 2. The photoreceptor 2 is uniformly charged by the charging section, and receives a light image irradiated from the image exposing section, so that an electrostatic latent image corresponding to the light image is formed on a surface of the photoreceptor 2. The image exposing section includes, for example, a laser irradiation unit. The image exposing section selectively controls driving of a semiconductor laser in accordance with image data so that the light image is irradiated to the surface of the photoreceptor 2.

The electrostatic latent image formed on the surface of the photoreceptor 2 is developed, with toner serving as a coloring agent, by the developing section so as to become a visible image (toner image). The toner image thus formed is appropriately transferred by the transfer section onto the paper sheet transported from a paper sheet feeding section described later. Thereafter, the paper sheet thus having the transferred toner image is sent to a fixing device 3 provided in an upper portion of the image forming process section.

Further, after the toner image is transferred onto the paper sheet as such, some toner remains on the surface of the photoreceptor 2. The toner thus remaining even after the toner image transfer is removed and collected by the cleaning section. Furthermore, an electric charge remaining on the surface of the photoreceptor 2 is removed by the electricity removing section. Thus, the image forming process section is prepared for the next image formation.

Described above are the arrangement and the operation of the image forming process section. The toner image is fixed on the paper sheet when the paper sheet passes through the fixing device 3. Then, the paper sheet is ejected, via an ejection roller 5, to a paper sheet ejecting section (ejection tray) 4 provided in the upper portion of the image forming process section.

The following explains the paper sheet feeding section for feeding the paper sheet into the image forming process section. The paper sheet feeding section includes a paper sheet feeding cassette 6, a paper sheet feeding unit 8, and a manual paper sheet feeding section 14.

The paper sheet feeding cassette 6 is provided below the image forming process section. The paper sheet stored in the paper sheet feeding cassette 6 is fed by using a paper sheet feeding roller. The paper sheet thus fed is transported to a resist roller 7 via a transportation path having a guide. The resist roller 7 is provided in front of the image forming process section (i.e., upstream of a direction (paper sheet transportation direction) in which the paper sheet is transported.

The paper sheet feeding unit 8 is provided below the paper sheet feeding cassette 6, separately from the paper sheet feeding cassette 6. The paper sheet feeding cassette 8 is formed in one piece with either (i) a unit in which the image forming apparatus 1 is installed, or (ii) the main body of the image forming apparatus 1. Further, the paper sheet feeding unit 8 includes three paper sheet feeding cassettes 9, 10, and 11 which are provided on top of one another. The paper sheet feeding unit 8 uses the paper sheet feeding roller so as to send a paper sheet selectively from any one of the paper sheet feeding cassettes 9, 10, and 11 to a paper sheet feeding path 12. The paper sheet feeding path 12 connected with each of the paper sheet feeding cassettes 9, 10, and 11 is connected to the transportation path connected to the resist roller 7 described above.

The manual paper sheet feeding section (manual paper sheet feeding unit) 14 transports one or more paper sheets of a given size such that the image forming apparatus carries out the image formation with respect to the paper sheets. The manual paper sheet feeding section 14 is provided separately from the paper sheet feeding cassette 6 and the paper sheet feeding unit 8.

The manual paper sheet feeding section 14 sends the paper sheet to a manual transportation path (first transportation path) 13 provided in the main body of the image forming apparatus 1. The manual paper sheet feeding section 14 is so installed as to meet the manual transportation path 13. The manual paper sheet feeding section 14 is detachable from the image forming apparatus 1. The arrangement of the manual paper sheet feeding section 14 will be described later.

The manual transportation path 13 is connected to the transportation path connected to the resist roller 7 described above. Specifically, the manual transportation path 13 is connected the resist roller 7 via the paper sheet feeding path 12, so that the paper sheet manually fed is transported to the resist roller 7 via the paper sheet feeding path 12.

As described above, the paper sheet fed from any one of the paper sheet feeding cassette 6, the paper sheet feeding unit 8, and the manual paper sheet feeding section 14 is sent to the resist roller 7, which is provided in front of the image forming process section. The resist roller 7 temporarily suspends the transportation of the paper sheet thus transported. At such a timing that the head of the paper sheet is aligned with the head of the toner image formed on the photoreceptor 2, the resist roller 7 is so controlled as to drive such that the transportation of the paper sheet is resumed. In other words, the transportation of the paper sheet is suspended by the resist roller 7, and then the paper sheet is transported to the transfer section of the photoreceptor 2 at the aforementioned timing. In this way, the toner image is transferred onto a predetermined position of the paper sheet.

Thus, the following operation is carried out in cases where the image formation is carried out with respect to a side (one side) of the paper sheet. That is, any one of the paper sheet feeding sections is selected. A paper sheet is fed from the selected one of the paper sheet feeding sections, and is transported to the resist roller 7. Thereafter, the toner image formed on the surface of the photoreceptor 2 is transferred onto the paper sheet. The paper sheet is transported to the fixing device 3, and then is ejected to the ejection tray 4. In this case, the paper sheet is ejected so that the side subjected to the image forming faces down.

The image forming apparatus 1 includes such a basic arrangement as described above and carries out the image formation with respect to one side of the paper sheet. Further, according to need, a reverse transportation unit (paper sheet transporting device) 15 for use in double side image formation is installed in the main body of the image forming apparatus 1 such that image formation is carried out with respect to the other side of the paper sheet, i.e., with respect to the side not subjected to the image formation. As illustrated in FIG. 2, the reverse transportation unit 15 is installed on the same side of the image forming apparatus as the manual paper sheet feeding section 14 is installed.

The reverse transportation unit 15 includes an entrance 16, an exit 17, and a sub-transportation path 18. The entrance 16 receives the paper sheet transported from the main body of the image forming apparatus 1. The exit 17 sends out the paper sheet to the image forming apparatus 1. The sub-transportation path 18 connects the entrance 16 to the exit 17. Further, a plurality of transportation rollers 19 are provided along the sub-transportation path 18 for the purpose of transporting the paper sheet. Note that the transportation rollers 19 are also provided in positions facing the entrance 16 and the exit 17.

Further, paper sheet transportation paths 20 and 21 are provided in the image forming apparatus 1 such that: the paper sheet transportation path 20 corresponds to the entrance 16, and the paper sheet transportation path (reverse transportation path) 21 corresponds to the exit 17. The paper sheet transportation path 20 meeting the entrance 16 is a reverse path for the switch-back transportation, i.e., for transporting the paper sheet whose transportation direction is reversed by reversing rotation of the ejection roller 5 immediately before ejecting the paper sheet via the ejection roller 5. Further, the paper sheet transportation path 21 is used for the sake of transporting the paper sheet to the resist roller 7 via the sub-transportation path 18. The paper sheet transportation path 21 meets the paper sheet feeding path 12 extending from the paper sheet feeding cassette 6 and the paper sheet feeding unit 8.

Thus, the reverse transportation unit 15 is installed in the main body of the image forming apparatus 1. With this, the paper sheet is transported again to the image forming section (image forming process section) such that the image formation (double side image formation) is carried out with respect to the other side of the paper sheet after the image formation having been carried out with respect to one side thereof. In this case, the respective positions of the entrance 16 and the exit 17 of the reverse transportation unit 15 are determined such that the entrance 16 and the exit 17 respectively meet the transportation paths 20 and 21 provided in advance in the image forming apparatus 1.

Moreover, as illustrated in FIG. 2, the image forming apparatus 1 according to the present embodiment is arranged such that: a manual paper sheet input vent 22 is provided in the reverse transportation unit 15 for the purpose of (i) installing the manual paper sheet feeding section 14, and (ii) feeding the paper sheet from the manual paper sheet feeding section 14 to the resist roller 7. The manual paper sheet input vent 22 is provided on the rear surface of the reverse transportation unit 15 so as to meet the exit 17 (i.e., provided on the surface opposite to the surface facing the image forming apparatus 1). The manual paper sheet input vent 22 is connected to the exit 17 via the transportation roller 19 such that the manual paper sheet input vent 22 and the exit 17 are in a substantially straight line.

Described in the following is an example of installing the paper sheet feeding device 30 in the image forming apparatus 1.

In cases where the image forming apparatus 1 shown in FIG. 2 requires a large-capacity paper sheet feeding device apart from the paper sheet feeding cassette 6 and the paper sheet feeding unit 8 each provided in advance in the image forming apparatus 1, the large-capacity paper sheet feeding device needs to be installed in the image forming apparatus 1.

In such a case, the paper sheet feeding device 30 can be installed, as an option, in the image forming apparatus 1. As illustrated in FIG. 1, the paper sheet feeding device 30 is installed in the image forming apparatus 1 so that the paper sheet is fed from the paper sheet feeding device 30 to the image forming apparatus 1 via the manual transportation path 13. That is, the paper sheet feeding device 30 is installed in the same position as the position in which the manual paper sheet feeding section 14 is installed in FIG. 2.

As illustrated in FIG. 1, the paper sheet feeding device 30 includes a paper sheet feeding transportation path 31, a paper sheet feeding vent 32, and a paper sheet storage section 33. The paper sheet feeding transportation path 31 is used for the paper sheet transportation from the paper sheet storage section 33 to the paper sheet feeding vent 32. The paper sheet feeding vent 32 is provided in the lowermost stream position, in the paper sheet transportation direction, of the paper sheet feeding transportation path 31 so as to meet the manual transportation path 13. Provided in the paper sheet storage section 33 are: a loading plate 34, a lift-up mechanism (not shown), a pickup roller (paper sheet picking roller) 35, a feed roller (paper sheet feeding roller) 36, a reverse roller (separation roller) 37, and the like.

The paper sheets are so stored in the paper sheet storage section 33 as to be stacked on one another in a predetermined position of the loading plate 34. The lift-up mechanism moves up and down the loading plate 34 so as to locate, at a predetermined height, a top surface of the uppermost one of the paper sheets loaded on the loading plate 34. The paper sheet picking roller 35 is arranged so as to be movable in upward and downward. Upon feeding the paper sheets, the paper sheet picking roller 35 is moved down so as to feed the uppermost one of the paper sheets loaded on the loading plate 34. The paper sheet feeding roller 36 and the separation roller 37 are provided face to face, away from the paper sheet picking roller 35 in the downstream of the paper sheet transportation direction.

The paper sheet feeding roller 36 is driven to rotate in the same direction as the paper sheet picking roller 35 rotates. The separation roller 37 is driven to rotate in the same direction as the paper sheet feeding roller 36 rotates. Therefore, at the position where the separation roller 37 faces the paper sheet feeding roller 36, the rotation of the separation roller 37 is opposite to the direction in which the paper sheet is fed. With this, paper sheets fed by the paper sheet picking roller 35 are separated by the paper sheet feeding roller 36 and the separation roller 37, and the uppermost paper sheet is sent out by the paper sheet feeding roller 36 to the paper sheet feeding transportation path 31. When there is another paper sheet under the sent paper sheet as described above, the feeding roller 36 works such that the paper sheet under the sent paper is returned to the paper sheet storage section 33. Thus, the paper sheets fed from the paper sheet storage section can be sent out one by one to the paper sheet feeding transportation path 31.

Provided in the downstream of the paper sheet transportation direction from the paper sheet feeding roller 36 and the separation roller 37 is a transportation roller 38. Further, the paper sheet feeding vent 32 is provided in the further downstream of the paper sheet transportation direction from the transportation roller 38. The paper sheet feeding vent 32 ejects the paper sheet from the paper sheet feeding device 30.

As described above, in cases where the paper sheet feeding device 30 is installed in the image forming apparatus 1, the manual paper sheet feeding section 14 installed to transport the paper sheet via the manual transportation path 13 is detached, and the paper sheet feeding device 30 is installed in the position in which the manual paper sheet feeding section 14 is installed. In this case, the paper sheet feeding device 30 is installed so that the paper sheet feeding vent 32 of the paper sheet feeding device 30 is connected to the manual transportation path 13 provided in the image forming apparatus 1. With this, the paper sheets can be fed from the paper sheet storage section 33 storing a large number of paper sheets. Accordingly, when the large-capacity image formation is carried out, the paper sheets stored in the paper sheet storage section 33 can be transported to the image forming apparatus 1 so as to be subjected to the image formation.

In cases where the paper sheet feeding device 30 is installed, respective connectors (not shown) of the image forming apparatus 1 and the paper sheet feeding device 30 are electrically connected. This electric connection makes it possible to (i) supply power to a motor serving as a driving source of the paper sheet feeding device 30, (ii) send a driving control signal from the image forming apparatus 1, and (iii) send and receive a detection signal and the like to/from a paper sheet detecting sensor provided in the paper sheet feeding device 30. The connectors are disconnected when the paper sheet feeding device 30 is detached.

In cases where the paper sheet feeding device 30 is thus installed, the manual paper sheet feeding section 14 is detached. This makes it impossible to use the manual paper sheet feeding section 14 in the conventional image forming apparatus. In contrast, the image forming apparatus 1 according to the present embodiment is arranged such that the manual paper sheet feeding section 14 can be installed in the rear surface of the reverse transportation unit 15 used for the double-side image formation, as illustrated in, e.g., FIG. 1. With this, the manual paper sheet feeding section 14 can be used.

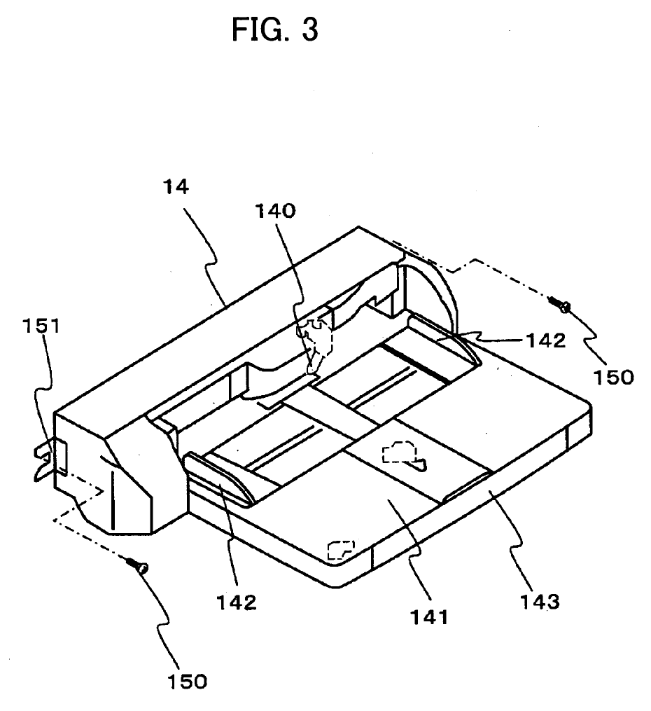

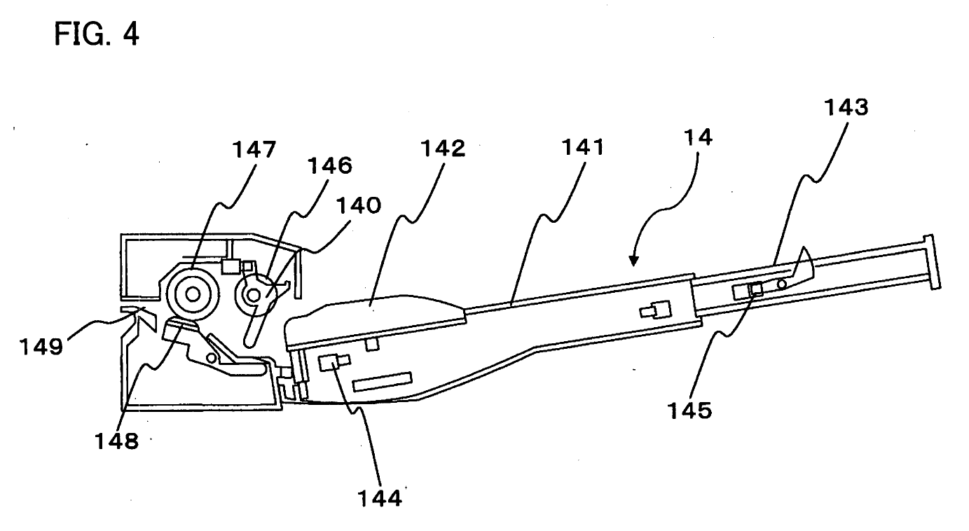

Here, the arrangement of the manual paper sheet feeding section 14 will be described. FIG. 3 is a perspective view of the manual paper sheet feeding section 14, and FIG. 4 is a cross-sectional view of the manual paper sheet feeding section 14. As illustrated in FIGS. 3 and 4, the paper sheet feeding section 14 has a loading tray 141. It is possible to load (set) a plurality of paper sheets on the loading tray 141. The loading tray 141 includes a width regulating plate 142 for regulating both ends of each of the paper sheets loaded. The width regulating plate 142 is so provided as to be movable in a direction orthogonal to the paper sheet feeding direction. This makes it possible to set paper sheets of a given size on the manual paper sheet feeding section 14 such that the width regulating plate 142 regulates the width of the paper sheet. Further, the loading tray 141 includes an extendable tray 143 that can be moved in the paper sheet feeding direction. This makes it possible to set, on the loading tray 141, a paper sheet that is long in the paper sheet feeding direction.

Further, as illustrated in FIG. 4, detection sensors 144 and 145 are provided in the manual paper sheet feeding section 14 in order to detect a size of the paper sheet loaded on the loading tray 141. The detection sensor 144 detects the width of the paper sheet. In other words, the detection sensor 144 detects a movement zone of the width regulating plate 142. Further, the detection sensor 145 is provided in the extendable tray 143, and detects the rear end of the paper sheet in the paper sheet feeding direction. The size of the loaded paper sheet is detected in accordance with detection results obtained by the detention sensors 144 and 145. As this paper size detection method, a conventional well-known detection method can be used without modification.

Further, see FIG. 4. Provided in the manual paper sheet feeding section 14 are: a paper sheet picking roller 146, a paper sheet feeding roller 147, and a friction member 148. The paper sheet picking roller 146 is provided in a position corresponding to the head of the loaded sheet paper. The friction member 148 is provided so as to be pressed against the paper sheet feeding roller 147. The friction member 148 is pressed against the paper sheet feeding roller 147 with an appropriate force exerted by a pressure member (not shown) such as a spring.

The friction member 148 has the same function as the separation roller 37 of the paper sheet feeding device 30 described above. That is, when the paper sheet picking roller 146 picks a plurality of paper sheets, the paper sheet(s) under the uppermost paper sheet are prevented by the friction member 148 from being sent, so that the paper sheet feeding roller 147 sends only the uppermost paper sheet. The paper sheet thus sent by the paper sheet feeding roller 147 is sent out from a manual paper sheet feeding vent 149.

Further, there is provided a paper sheet detection sensor 140 in the position corresponding to the head of each of the loaded paper sheets. The paper sheet detection sensor 140 detects the paper sheet loaded on the loading tray 141. When the paper sheet detection sensor 140 detects the paper sheet, a control section (not shown) provided in the image forming apparatus 1 drives the components such that the manual paper sheet feeding section 14 feeds the paper sheet. That is, when the paper sheet of the paper sheet feeding section 14 is selected under such conditions that the paper sheet detection sensor 140 detects that the paper sheet is loaded on the loading tray 141, the paper sheet is fed from the manual paper sheet feeding section 14 to the image forming process section of the image forming apparatus 1.

As such, the manual paper sheet feeding section 14 is detachably provided in the image forming apparatus 1. For example, in cases where the manual paper sheet feeding section 14 is installed in the position shown in FIG. 2, the manual paper sheet feeding section 14 is installed in such a position (not shown) of the image forming apparatus 1 that the manual transportation path 13 of the image forming apparatus 1 meets the manual paper sheet feeding vent 149 of the manual paper sheet feeding section 14. The manual paper sheet feeding section 14 thus installed is fixed, by a fixing part 151 with the use of a screw 150, to the main body of the image forming apparatus 1 as shown in FIG. 3.

The manual paper sheet feeding section 14 can be easily detached from the image forming apparatus 1 by removing the screw 150. Then, the paper sheet feeding device 30 is installed in the image forming apparatus 1, i.e., in the position from which the manual paper sheet feeding section 14 was detached. With this, the paper sheet fed from the paper sheet feeding device 30 is sent to the image forming process section via the manual transportation path 13.

See a case where the paper sheet feeding device 30 is installed but the manual paper sheet feeding section 14 is still usable. For the attainment of this, the manual paper sheet feeding section 14 is positioned and fixed in the reverse transportation unit 15 by the fixing part 151 with the use of the screw 150 so that the manual paper sheet feeding vent 149 of the manual paper sheet feeding section 14 meets the manual paper sheet input vent 22 provided on the rear surface of the reverse transportation unit 15. Thus, even when the paper sheet feeding device 30 is installed, the manual paper sheet feeding section 14 can be used for the image formation to be carried out with respect to a paper sheet of a given size.

The manual paper sheet feeding section 14 is installed in and detached from the image forming apparatus 1 in the same manner as in the case of installing and detaching the paper sheet feeding device 30. That is, the connector of the image forming apparatus 1 is connected to and disconnected from a connector (not shown) of the manual paper sheet feeding section 14, so that electric connection and disconnection are carried out. This electric connection makes it possible to (i) supply power for driving and control and (ii) send and receive a control signal. As the connectors, well-known general connectors may be used.

As described above, the paper sheet feeding device 30 for carrying out the large-capacity image formation is installed in the image forming apparatus 1 according to the present embodiment. This makes it possible to (i) carry out the large-capacity image formation and (ii) ease the troublesome task of changing the paper sheets in the middle of the image formation. The paper sheet from the paper sheet feeding device 30 maintains substantially in a fixed position while being transported to the image forming apparatus 1. This makes it possible to reduce or suppress a jam or the like in the paper sheet feeding device 30.

Further, even when the paper sheet feeding device 30 is installed, the manual paper sheet feeding section 14 can be used as has been conventionally done. Therefore, the image formation can be easily carried out with respect to a small number of paper sheets of a given size, so that user-friendliness can be improved. Moreover, each of the transportation paths is not greatly bent, so that the paper sheet can be transported from the manual paper sheet feeding section 14 to the image forming apparatus 1 via such a substantially straight transportation path. This makes it possible to reduce or suppress the jam in the paper sheet feeding section 14.

In the present embodiment, the manual paper sheet feeding section 14 is detachably installed in the image forming apparatus 1, and a plurality of positions for installing the manual paper sheet feeding section 14 are provided therein. This brings about the aforementioned effect that: even when such a high capacity paper sheet feeding device 30 is installed, the manual paper sheet feeding section 14 can be used together with the paper sheet feeding device 30. Moreover, in the present embodiment, the positions for installing the manual paper sheet feeding section 14 do not need to be provided specially. In other words, the existing transportation paths are respectively used for the positions, without modification.

That is, the paper sheet feeding is carried out in the present embodiment such that: the reverse transportation path 21 provided in advance in the image forming apparatus 1 for the attainment of the double side image formation is used as a second transportation path for transporting the paper sheet from the manual paper sheet feeding section 14. With this, even when the reverse transportation unit 15 allowing the double-side image formation is installed in the image forming apparatus 1, the manual paper sheet feeding section 14 can be installed so as to meet the manual paper sheet input vent 22 which is connected to the reverse transportation path 21 and which is provided in the reverse transportation unit 15. Thus, there is no need to newly provide the positions for installing the manual paper sheet feeding section 14. This prevents the image forming apparatus 1 from being large. The objects of the present invention can be attained with such a simple arrangement. In addition, this allows simplification of designing or the like of the image forming apparatus 1.

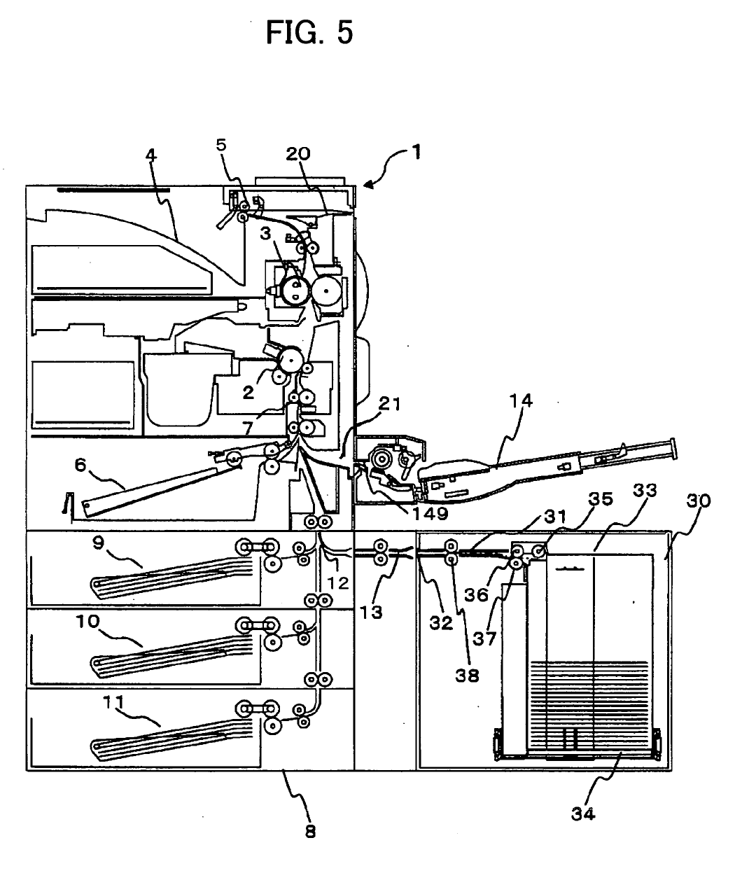

FIG. 1 illustrates a case of applying the present invention to the image forming apparatus 1 that allows the double-side image formation, i.e., to the image forming apparatus 1 in which the reverse transportation unit 15 is installed. However, the present invention is not limited to this, but may be applied, without any modification, to an image forming apparatus that does not carry out the double-side image formation. That is, when the double-side image formation does not need to be carried out, no reverse transportation unit 15 is provided, i.e., the reverse transportation unit 15 is detached from the image forming apparatus 1. Even in such an image forming apparatus 1, the manual paper sheet feeding section 14 can be used together with the paper sheet feeding device 30. In this case, the manual paper sheet feeding section 14 is installed in the image forming apparatus 1 so that the manual paper sheet feeding vent 149 of the manual paper sheet feeding section 14 meets the reverse transportation path 21 as illustrated in FIG. 5. With this, even when either the paper sheet feeding device 30 or the manual paper sheet feeding section 14 is selected to feed the paper sheet, the image can be formed on one side of the paper sheet.

Further, in the present embodiment, the paper sheet to be sent out from the paper sheet feeding device 30 to the image forming apparatus 1 is transported through the transportation paths that extend substantially straightly. This brings about an effect of preventing the jam from occurring in the paper sheet feeding device 30. Further, the paper sheet fed from the manual paper sheet feeding section 14 is not sent out to the manual transportation path 13, but is sent to the reverse transportation path 21 which serves as the second transportation path, and which is provided separately from the manual transportation path 13. Accordingly, the paper sheet can be transported via such a substantially straight transportation path, as described above. As such, no transportation paths need to be greatly curved or bent. This simplifies designing and assembly of the paper sheet feeding device 30. Further, the manual paper sheet feeding section 14 can be used without modifying the structure thereof.

Further, since the reverse transportation path 21 of the image forming apparatus 1 is so arranged as to receive the paper sheet from the manual paper sheet feeding section 14, there is no need to separately form a special transportation path for feeding the paper sheet to the image forming process section. Therefore, there is no need to separately provide the special transportation path in the image forming apparatus 1. This prevents the image forming apparatus from being large, and simplifies the designing of the image forming apparatus 1.

### Second Embodiment

The arrangement of the paper sheet feeding device 30 of the first embodiment is such an arrangement that stores one type of paper sheet. The following explains an embodiment which can store a plurality of types of paper sheet.

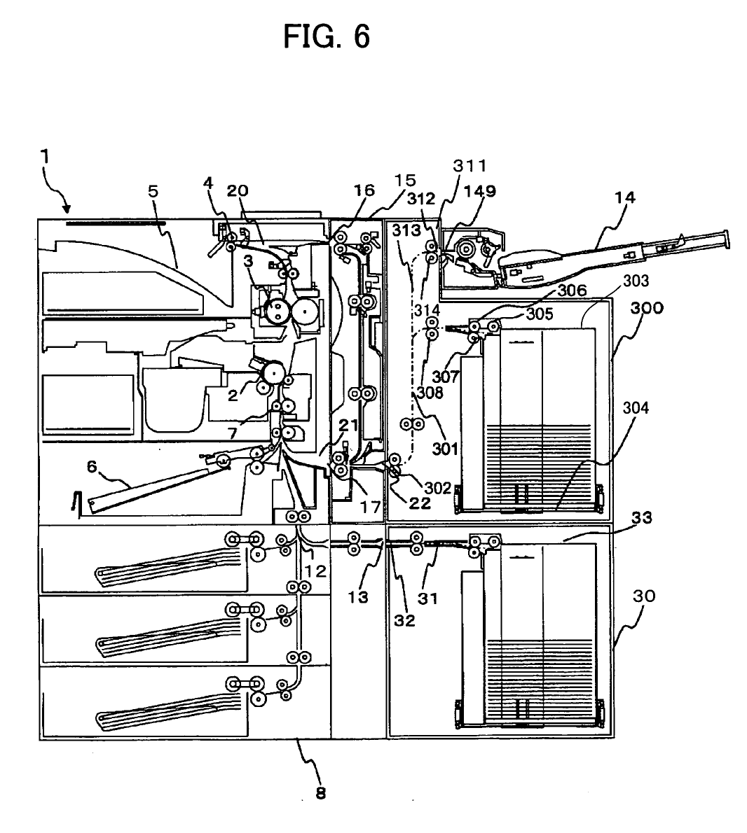

When feeding two types of paper sheet from the paper sheet feeding device installed in the image forming apparatus, the conventional image forming apparatus is arranged such that: the paper sheet transportation paths are greatly bent in the paper sheet feeding device; and the paper sheet transportation paths meet together at one point such that one transportation path is formed and extends to the image forming apparatus. As a result, the jam or the like is likely to occur in the bent portions, the meeting point, or the like. In contrast, the present embodiment provides a paper sheet feeding device capable of suppressing or reducing such a jam. FIG. 6 is a block diagram illustrating one example of the image forming apparatus 1 according to the present embodiment.

As illustrated in FIG. 6, the paper sheet feeding device 300 includes a first storage section 33 and a second storage section 303 which are capable of storing paper sheets of different sizes. That is, the first storage 33 is provided in a lower portion of the paper sheet feeding device 300, and the second storage section 303 is provided in an upper portion of the paper sheet feeding device 300. The first storage section 33 corresponds to the paper sheet storage section described in FIG. 1. That is, the first storage section 33 has the same arrangement and function as the paper sheet storage section described in FIG. 1 has. Therefore, explanation thereof is omitted below.

The second storage section 303 includes a transportation path 301 connected to the manual paper sheet input vent 22 of the reverse transportation unit 15 for allowing the double side image formation. The second storage section 303 is installed such that the paper sheet feeding vent 302 provided in the lowermost stream of the transportation path 301 meets the manual paper sheet input vent 22. In addition to the transportation path 301, the second storage section 303 includes a loading tray 304, a lift-up mechanism (not shown), a pickup roller (paper sheet picking roller) 305, a feed roller (paper sheet feeding roller) 306, and a reverse roller (separation roller) 307.

The paper sheets are so stored in the second storage section 303 to be stacked on one another in a predetermined position of the loading plate 304. The lift-up mechanism moves up and down the loading plate 304 so as to locate, at a predetermined height, a top surface of the uppermost one of the paper sheets loaded on the loading plate 304. The paper sheet picking roller 305 is arranged so as to be movable in upward and downward. Upon feeding the paper sheets, the paper sheet picking roller 305 is moved down so as to feed the uppermost one of the paper sheets loaded on the loading tray 304. The paper sheet feeding roller 306 and the separation roller 307 are provided face to face, away from the paper sheet picking roller 305 in the downstream of the paper sheet transportation direction.

The paper sheet feeding roller 306 is driven to rotate in the same direction as the paper sheet picking roller 305 rotates. The separation roller 307 is driven to rotate in the same direction as the paper sheet feeding roller 306 rotates. Therefore, at the position where the separation roller 307 faces the paper sheet feeding roller 306, the rotation of the separation roller 307 is opposite to the direction in which the paper sheet is fed. With this, paper sheets fed by the paper sheet picking roller 305 are sent out, through the paper sheet feeding roller 306 and the separation roller 307, to the transportation path 301. The paper sheets are then supplied to the image forming apparatus 1 via the paper sheet feeding vent 302. The transportation path 301 is appropriately provided with a plurality of paper sheet transportation rollers 308.

As described above, the paper sheet feeding section 14 is detached from the image forming apparatus 1, and the paper sheet feeding device 300 is installed in the position from which the paper sheet feeding section 14 was detached. In this case, the paper sheet feeding device 300 is installed so that the paper sheet feeding vent 32 corresponding to the first storage section 33 is connected to the manual transportation path 13 provided in the image forming apparatus 1. Further, the paper sheet feeding vent 302 corresponding to the second storage section 303 is connected to the manual paper sheet input vent 22 of the reverse transportation unit 15 installed in the image forming apparatus 1. This makes it possible to supply the paper sheets from the first storage section 33 or the second storage section 303 storing a large number of paper sheets. Therefore, the first storage section 33 or the second storage section 303 is selected to feed the paper sheets to the image forming apparatus 1, so that the large-capacity image formation is carried out.

The present embodiment explains the paper sheet feeding device 300 including the storage section 33 and 303 provided on top of each other. However, the present invention is not limited to this. For example, the first paper sheet storage device 30 and the second paper sheet feeding device 300 can be separated. Specifically, the first storage section 33 provided below the second storage section 303 is replaced with the first paper sheet storage device 30, and the second storage section 303 provided above the first storage section 33 is replaced with the second paper sheet feeding device 300. In this case, for example, when another large-capacity paper sheet feeding device, i.e., the second paper sheet feeding device 300 needs to be provided in the image forming apparatus 1 in which the paper sheet feeding device 30 and the manual paper sheet feeding section 14 are installed as illustrated in FIG. 1, the manual paper sheet feeding section 14 may be detached and the second paper sheet feeding device 300 may be installed above the first paper sheet feeding device 30. With this arrangement, the large-capacity image formation using two types of paper sheets can be carried out in the same manner as is the case with the paper sheet feeding device 300 illustrated in FIG. 6.

Further, in the present embodiment, there is provided an installation part 311 for installing the manual paper sheet feeding section 14 in the upper portion of the paper sheet feeding device 300. Thus, when the manual paper sheet feeding section 14 is required, the manual paper sheet feeding section 14 can be installed in the installation part 311 as illustrated in FIG. 6, and be used. Formed in the installation part 311 is a paper sheet input vent 312 corresponding to the manual paper sheet feeding vent 149 of the manual paper sheet feeding section 14. The paper sheet input vent 312 is so provided as to meet a connecting transportation path 313 connected to the transportation path 301 described above. Therefore, the paper sheet input vent 312 is provided in the upstream of the connecting transportation path 313. Provided in the paper sheet input vent 312 is a transportation roller 314. The transportation roller 314 sends, to the transportation path 301, the paper sheet transported from the manual paper sheet feeding section 14.

Therefore, when the manual paper sheet feeding section 14 installed as shown in, e.g., FIG. 1 is detached and the paper sheet feeding device 300 is installed instead as shown in FIG. 6, the manual paper sheet feeding section 14 thus detached is installed, as needed, in the installation part 311 provided in the upper portion of the paper sheet feeding device 300.

According to the paper sheet feeding device 300 arranged as described above, the paper sheet fed selectively from any one of the first storage section 33 and the second storage section 303 which are provided on top of each other is supplied, through either the manual transportation path 13 or the reverse transportation path (double-side transportation path) 21, to the image forming process section serving as the image forming section. In this case, the paper sheet fed from the first storage section 33 provided below the second storage section 303 is supplied to the image forming apparatus 1 through the substantially straight transportation path 31. This makes it possible to prevent the jam or the like. Further, the paper sheet sent out from the second storage section 303 provided above the first storage section 33 is not sent via the transportation path 31, but is sent to the image forming process section via the manual paper sheet input vent 22 connected directly to the image forming apparatus 1. This makes it possible to prevent the paths from meeting at one point and to accordingly suppress or reduce the jam at the point.

Further, since the manual paper sheet feeding section 14 is installed in the upper portion of the paper sheet feeding device 300, the manual paper sheet feeding section 14 never becomes an obstacle of the paper sheet feeding device 300, and the manual paper sheet feeding can be carried out. Moreover, the paper sheet manually fed is sent to the image forming apparatus 1 through the connecting transportation path 313 connected to the transportation path 301 guiding the paper sheet sent out from the second storage section 303. Thus, the paper sheet can be supplied to the image forming apparatus 1 through the existing transportation path 301. Therefore, there is no need to separately provide a special path, and the existing transportation path 301 is used for the transportation of the paper sheet to the image formation apparatus 1. This makes it possible to reduce the jam or the like.

The image forming apparatus 1 of the present invention is arranged so as to include the image forming section provided with the image forming process section that adopts the electrophotographic method. However, the present invention is not limited to this, but may be an image forming apparatus including another image forming section. For example, the image forming section may carry out the image formation in accordance with the ink-jet method. Alternatively, the image forming section may carry out the image formation in accordance with the offset printing method or the like. In other words, the image forming section may be such an image forming section that merely forms an image on the paper sheet.

That is, the present invention can be applied to any image forming apparatus including (i) an image forming section; (ii) a paper sheet feeding device capable of automatically feeding a paper sheet into the image forming section; and (iii) a manual paper sheet feeding section provided separately from the paper sheet feeding device. Particularly, when the manual paper sheet feeding section is detached and a large-capacity paper sheet feeding device is installed instead, the manual paper sheet feeding section may be so arranged as to be connectable to another transportation path so that the paper sheet is fed from the manual paper sheet feeding section via the transportation path. When the image forming apparatus is provided with a double-side transportation path that allows double-side image formation, the double-side transportation path may be used without modification. Specifically, the manual paper sheet feeding section may be so installed as to correspond to the position of the double-side transportation path, and may be used.

The present embodiment explains the image forming apparatus including only two transportation paths each connectable to the manual paper sheet feeding section 14. However, the present invention is not limited to this. For example, the image forming apparatus may include three or more transportation paths each connectable to the manual paper sheet feeding section.

As described above, an image forming apparatus of the present invention includes: an image forming section for carrying out image formation with respect to a paper sheet fed thereto; (i) a manual paper sheet feeding section, which allows supply of an arbitrary paper sheet; and (ii) a plurality of transportation paths for receiving, from outside, the paper sheet to be transported to the image forming section, the manual paper sheet feeding section being detachably installed so as to be connected to an arbitrary transportation path selected from the transportation paths.

Thus, even when another paper sheet feeding device (e.g., large-capacity paper sheet feeding device) is so installed as to be connected to the transportation path instead of the manual paper sheet feeding section, the manual paper sheet feeding section can be connected to another transportation path. Therefore, even when the paper sheet feeding device is installed, the manual paper sheet feeding section can be used to feed the paper sheet.

In this case, since the manual paper sheet feeding section and the paper sheet feeding device are connected to the different transportation paths, the paths do not meet at one point. This makes it possible to prevent a jam or the like, thereby allowing stable paper sheet feeding.

When the manual paper sheet feeding section can be detachably connected to (i) a first transportation path in which the manual paper sheet feeding section is regularly installed and (ii) a second transportation path different from the first transportation path, one of the transportation paths may be used as the second transportation path.

For example, the image forming apparatus may be arranged such that: at least one of the transportation paths is connected to a reverse transportation path for resupplying, to the image forming section, the paper sheet having a side subjected to the image formation carried out by the image forming section, so that the image formation is carried out with respect to the other side of the paper sheet.

Further, the image forming apparatus may be arranged such that: a paper sheet feeding device is so installed as to be connectable to one of the transportation paths; and the manual paper sheet feeding section is so installed as to be connectable to a transportation path different from the transportation path connected to the paper sheet feeding device. This makes it possible to install the paper sheet feeding device and the manual paper sheet feeding section for concurrent use.

Further, the image forming apparatus may be arranged such that: the manual paper feeding section is detachable and one or more paper sheet feeding devices are connectable to the transportation paths. According to the foregoing arrangement, a plurality of paper sheet feeding devices can be installed.

Further, the image forming apparatus may be arranged such that: at least one of the paper sheet feeding devices has an installation part for installing the manual paper sheet feeding section; and the paper sheet fed from the manual paper sheet feeding section is transported from the installation part to the image forming section via the transportation path connected to the paper sheet feeding device having the installation part. That is, the transportation path for transporting the paper sheet fed from the manual paper sheet feeding section installed in the installation part may be arranged to meet the transportation path for transporting, to the image forming apparatus, the paper sheet stored in the paper sheet feeding device. The foregoing arrangement makes it possible to use the manual paper sheet feeding section while installing the paper sheet feeding devices.

The image forming apparatus may further include: a reverse path for reversing the paper sheet ejected from the image forming section and for transporting the paper sheet; and (ii) a reverse transportation unit, which is so installed as to connect the reverse path to the reverse transportation path, wherein: a paper sheet input transportation path is so provided in the reverse transportation unit as to be connected to the reverse transportation path, and the manual paper sheet feeding section is connectable to the paper sheet input transportation path.

The forgoing arrangement makes it possible to use the manual paper sheet feeding section even when the reverse transportation unit is installed.

A paper sheet transporting device of the present invention is installed in an image forming apparatus so as to resupply, to a transportation path for transporting a paper sheet to an image forming section, a paper sheet ejected from an image forming section of the image forming apparatus, the paper sheet transporting device including: an entrance for receiving the paper sheet ejected from the image forming section; an ejection vent for ejecting, to the transportation path of the image forming apparatus, the paper sheet received from the entrance; and a paper sheet input vent for receiving a paper sheet from a manual paper sheet feeding section, which allows supply of an arbitrary paper sheet and which is so detachably installed as to be connected to the paper sheet input vent, the paper sheet thus received from the paper sheet input vent being transported to the transportation path of the image forming apparatus via the ejection vent.

According to the foregoing arrangement, the paper sheet fed from the manual paper sheet feeding section can be fed to the image forming apparatus via the paper sheet input vent.

A paper sheet feeding device of the present invention is installed in an image forming apparatus, the paper sheet feeding device including: a paper sheet storage section for storing a paper sheet; a paper sheet feeding vent for feeding, to a transportation path for transporting a paper sheet to an image forming section, the paper sheet stored in the paper sheet storage section; and an installation part for detachably installing a manual paper sheet feeding section, which allows supply of an arbitrary paper sheet, the paper sheet being fed from the manual paper sheet feeding section to the transportation path of the image forming apparatus via the paper sheet feeding vent.

According to the foregoing arrangement, even when the paper sheet feeding device is installed in the image forming apparatus, the manual paper sheet feeding section can be installed in the installation part of the paper sheet feeding device, and can be used.

The present invention is not limited to the description of the embodiments above, but may be altered by a skilled person within the scope of the claims. An embodiment based on a proper combination of technical means disclosed in different embodiments is encompassed in the technical scope of the present invention.

What is claimed is:

1. An image forming apparatus, comprising:
an image forming section for carrying out image formation with respect to a paper sheet fed thereto,
a manual paper sheet feeding section, which allows supply of an arbitrary paper sheet; and
a plurality of transportation paths for receiving, from outside, the paper sheet to be transported to the image forming section,
the manual paper sheet feeding section being detachably installed so as to be connected to a transportation path selected from the transportation paths.

2. The image forming apparatus as set froth in claim 1, wherein:
at least one of the transportation paths is connected to a reverse transportation path for resupplying, to the image forming section, the paper sheet having a side subjected to the image formation carried out by the image forming section, so that the image formation is carried out with respect to the other side of the paper sheet.

3. The image forming apparatus as set froth in claim 1, wherein:
a paper sheet feeding device is so installed as to be connectable to one of the transportation paths; and
the manual paper sheet feeding section is so installed as to be connectable to a transportation path different from the transportation path connected to the paper sheet feeding device.

4. The image forming apparatus as set forth in claim 1, wherein: the manual paper feeding section is detachable and one or more paper sheet feeding devices are connectable to the transportation paths.

5. The image forming apparatus as set forth in claim 4, wherein:
at least one of the paper sheet feeding devices has an installation part for installing the manual paper sheet feeding section; and
the paper sheet fed from the manual paper sheet feeding section is transported from the installation part to the image forming section via the transportation path connected to the paper sheet feeding device having the installation part.

6. The image forming apparatus as set forth in claim 2, further comprising:
a reverse path for reversing the paper sheet ejected from the image forming section and for transporting the paper sheet thus ejected; and
a reverse transportation unit, which is so installed as to connect the reverse path to the reverse transportation path,
wherein:
a paper sheet input transportation path is so provided in the reverse transportation unit as to be connected to the reverse transportation path, and
the manual paper sheet feeding section is connectable to the paper sheet input transportation path.

7. A paper sheet transporting device, which is installed in an image forming apparatus, and which resupplies, to a transportation path for transporting a paper sheet to an image forming section, a paper sheet ejected from the image forming section of the image forming apparatus,
the paper sheet transporting device, comprising:
an entrance for receiving the paper sheet ejected from the image forming section;
an ejection vent for ejecting, to the transportation path of the image forming apparatus, the paper sheet received from the entrance; and
a paper sheet input vent for receiving a paper sheet from a manual paper sheet feeding section, which allows supply of an arbitrary paper sheet and which is detachably installed,
the paper sheet thus received from the paper sheet input vent being transported to the transportation path of the image forming apparatus via the ejection vent.

8. A paper sheet feeding device, installed in an image forming apparatus,
the paper sheet feeding device, comprising:
a paper sheet storage section for storing a paper sheet;
a paper sheet feeding vent for feeding, to a transportation path for transporting a paper sheet to an image forming section, the paper sheet stored in the paper sheet storage section; and
an installation part for detachably installing a manual paper sheet feeding section, which allows supply of an arbitrary paper sheet,
the paper sheet being fed from the manual paper sheet feeding section to the transportation path of the image forming apparatus via the paper sheet feeding vent.
